(19) United States
(12) Patent Application Publication
(10) Pub. No.: US 2020/0364641 A1
(43) Pub. Date: Nov. 19, 2020

(54) SYSTEM AND METHOD FOR MANAGING TRANSPORTATION VESSELS

(71) Applicant: Target Brands, Inc., Minneapolis, MN (US)

(72) Inventors: Brooke Luedke, Minneapolis, MN (US); Matthew Titus, Minneapolis, MN (US); Saptarshi Saha, Bengaluru (IN); Vishal Gupta, Bengaluru (IN); Akshay Bhave, Bengaluru (IN); Samantha Stanke, Minneapolis, MN (US)

(21) Appl. No.: 16/413,464

(22) Filed: May 15, 2019

(51) Int. Cl. G06Q 10/06; G06Q 10/08; G06Q 10/04; G06Q 30/02

(52) U.S. Cl. CPC G06Q 10/06315; G06Q 10/08355; G06Q 30/0205; G06Q 10/047; G06Q 10/0832

(57) ABSTRACT

Methods and systems for managing transportation vessels in an enterprise system are disclosed. One method includes receiving inputs related to historical transportation vessel usage, the inputs including a transportation time, dwell time, and demand shipment. The method includes automatically determining a best fit distribution for each of the usage characters, and performing, for each of the plurality of pairs of locations, a plurality of simulations using a randomly-selected value for each of the usage characteristics. Each of the plurality of simulations includes an optimized output of a number of transportation vessels required to meet a demand for each pair of locations, such that the outputs of the plurality of simulations result in a range of numbers of transportation vessels required to meet a predetermined service level.

### TECHNICAL FIELD

The present disclosure is directed to methods and systems for managing transportation vessels within a retail enterprise system.

BACKGROUND

Retailers often have multiple nodes within an enterprise system. One such retailer network includes, e.g., distribution centers, flow centers (routing centers), and retail locations. The retailer is tasked with the job of maintaining appropriate inventory within each of the nodes and transporting inventory between the nodes as needed. In some instances, a retailer may own all or some of the transportation vessels needed to move inventory between nodes. In other instances, retailers rent some or all of the transportation vessels needed. Owning too many or too few transportation vessels results in increased costs and unused vessels.

Existing solutions optimizing or improving transportation vessel management can be made more difficult because demand for inventory items made changes over time. Further, the cost of transportation vessels depends on the ownership model for such transportation vessels, the distance between two nodes, and the time of transport between two nodes in a supply chain network. In view of the above-described challenges, managing transportation vessels that are used between multiple nodes in a retail enterprise system is an ongoing process in which improvements are continually sought and a static model is generally unsatisfactory.

### SUMMARY

In summary, the present disclosure relates to methods and systems for managing transportation vessels within an enterprise system.

In an example aspect, a method of managing transportation vessels within an enterprise system includes the following: a software tool implemented on a computing system receives inputs related to historical transportation vessel usage. The inputs include a historical demand level in a plurality of historical usage characteristics for each of a plurality of pairs of locations. A best fit distribution for each of the plurality of historical usage characteristics and historical demand is automatically determined from the historical transportation vessel usage information. Next, for each of the plurality of pairs of locations a plurality of simulations is performed. The plurality of simulations uses a randomly selected value for each of a plural characteristics. The randomly selected value is weighted according to the best fit distribution of the corresponding historical usage characteristics. Each of the plurality of simulations includes an output of a number of transportation vessels required to meet a demand for each pair of locations, such that, the outputs of the plurality of simulations resulting in a range of numbers of transportation vessels required to meet a predetermined service level.

In another example aspect, the system for managing transportation vessels within an enterprise system includes the following: a computing system including a data store, a processor, and a memory communicatively coupled to the processor, the memory storing instructions executable by the processor to execute the following steps. Receive input related to historical transportation vessel usage. The inputs include a historical demand level and a plurality of historical usage characteristics for each of a plurality of pairs of locations. A historical transportation vessel usage information and a best fit distribution is determined for each of the plurality of historical usage characteristics and the historical demand. For each of the plurality of pairs of locations, a plurality of simulations is performed using a randomly selected value for each of a plurality of usage characteristics. The randomly selected value is weighted according to the best fit distribution of the corresponding vessel usage characteristics. Each of the plurality of simulations includes an output of a number of transportation vessels required to meet a demand for each pair of locations, such that, the outputs of the plurality of simulations result in a range of numbers of transportation vessels required to meet a predetermined service level.

In a further aspect, a non-transitory computer-readable medium comprising computer-executable instructions, which when executed by computing system cause the computing system to perform a method of managing transportation vessels within an enterprise system. The method comprises receiving input related to historical transportation vessel usage. The inputs include a historical demand level and a plurality of historical usage characteristics for each of a plurality of pairs of locations. A historical transportation vessel usage information and a best fit distribution is determined for each of the plurality of historical usage characteristics and the historical demand. For each of the plurality of pairs of locations, a plurality of simulations is performed using a randomly selected value for each of a plurality of usage characteristics. The randomly selected value is weighted according to the best fit distribution of the corresponding vessel usage characteristics. Each of the plurality of simulations includes an output of a number of transportation vessels required to meet a demand for each pair of locations, such that the outputs of the plurality of simulations resulting in a range of numbers of transportation vessels required to meet a predetermined service level.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a schematic diagram of an example supply chain for a retail enterprise.

FIG. 2 illustrates a schematic diagram of an example transportation vessel management system.

FIG. 3 illustrates a more detailed view of the modeler of FIG. 2.

FIG. 4 illustrates an example method of managing transportation vessels within a retail enterprise system.

FIG. 5 illustrates an example graphical representation of one of the historical inputs.

FIG. 6 illustrates an example best fit historical model for transit time, dwell time, and demand.

FIG. 7 illustrates an example method of conducting a synthetic distribution process to generate a forecast output.

FIG. 8 illustrates a graphical representation the number of vessels needed per node pair.

FIG. 9 shows an example user interface for managing a transportation vessel system.

FIG. 10 illustrates an example block diagram of a computing system useful for implementing the transportation vessels management system.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

An enterprise system of the present disclosure utilizes an architecture of established retail sites, established flow centers associated with the retail sites, established receive centers for receiving product from vendors, and established hauling routes between receive centers, retail sites, and flow centers, herein referred to as “nodes.” The transportation vessel management system uses dynamic, stochastic modeling to determine a minimum number of transportation vessels required to meet a predetermined service level, to ensure that a predetermined transportation capacity is met at least a threshold amount of time based on anticipated need to move items between two nodes in a supply chain network.

In accordance with the present disclosure, it is noted that the hauling routes described herein are generally assumed as point-to-point routes in which a given load that is shipped from one node will, in its entirety, be dropped off at a second node. For example, a given load may be between a vendor and a receive center, or between a receive center and a retail site, or some similar arrangement, rather than from a particular distribution center to a plurality of different retail sites.

The transportation vessel management system is, in some embodiments, implemented on a data communication network that serves as a center for coordination of shipments between two enterprise nodes. In some embodiments, the system includes a collection of functions and features implemented in software and/or hardware that make the operation and management of transportation vessels as an automated process.

In general, the present disclosure relates to methods and systems for determining an optimized number of transportation vessels to meet a predetermined service level. The service level measures the performance of the system in meeting the delivery demands in a timely manner. In an example, a predetermined service level is 98%; however, other service levels are envisioned (e.g., 99%, 95%, 80% etc.). In some instances, the predetermined service level can be set by a user prior to optimization, and is freely configurable at any percentage service level. Additional features that may be considered when determining the number of transportation vessels needed include ownership costs, rental costs, leasing costs, currency and/or exchange rate fluctuations, fuel costs, transportation vessel size, and utilization rate. The selected number of transportation vessels used to meet the predetermined service level includes an optimum number of vessels while minimizing costs.

The methods and systems described herein provide efficiencies in transportation vessel usage by maximizing usage and minimizing downtime, ensuring that physical vessels are procured and coordinated between nodes to move goods between a set of nodes as efficiently as possible.

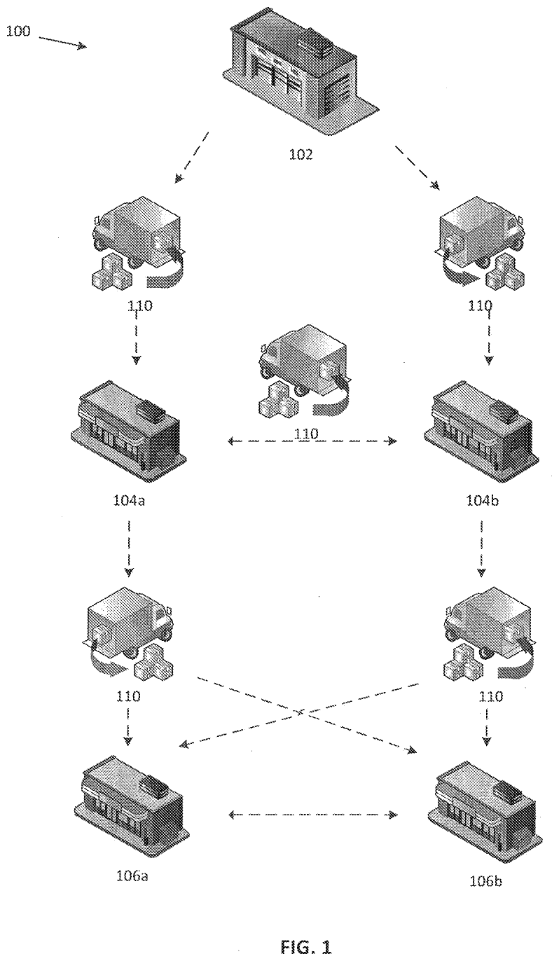

FIG. 1 illustrates a schematic diagram 100 of an example supply chain for a retail enterprise. The diagram 100 illustrates the flow of inventory from vendor 102. to retail locations 106. The inventory moves through various nodes to arrive at the customer. In this example, the nodes include a vendor 102, two distribution centers 104a, 104b, and two retail stores 106a, 106b. In practice, the supply chain could include many more nodes, including flow centers, and in different proportions. In some embodiments, there are additional and separate receive centers and flow centers that house inventory between vendor and retail store. Arrows in the diagram indicate movement of inventory. Inventory will typically flow downward through the supply chain, but in some instances inventory may move between distribution centers 104a, 104b and retail stores 106a, 106b.

Transportation vessels 110 move inventory between nodes. A first transportation vessel 110 may move inventory from vendor 102 to distribution center 104a. The same or a different transportation vessel 110 may move inventory from one retail store 106a to another retail store 106b. Still further, transportation vessels may be used to move inventory items between other nodes, such as between distribution centers 104a, 104b.

Vendor 102. produces/provides the items or products that will be sold by the retail entity. In some instances, the vendor 102 will transport the ordered products to a node within the retail enterprise. In other instances, the retail enterprise arranges for the inventory to be picked up from the vendor 102 and transported to the desired node. The inventory items may be transported in a variety of different transportation vessels 110, Example transportation vessels 110 include, but are not limited to, tractor-trailers, shipping containers, cargo ships, and aircraft cargo. Still further, different sizes and specialties (such as vessels including specialty equipment, such as refrigeration) for each of the transportation vessels are considered. Throughout this application, trailers are referred to as the transportation vessel 110, but this is not to be seen as limiting.

It is noted that, between distribution centers 104a, 104b, and retail stores 106a, 106b, there may be preexisting, predetermined delivery routes established. For example, there may be daily or weekly transit routes between a distribution center and one or more retail stores. The distribution center can provide to the retail location the selection of individual items that are needed by retail stores 106a, 106b serviced by the one or more distribution centers 104a, 104b proximate to and/or servicing those stores. The distribution centers 104a, 104b can also have daily or other periodic transportation routes established to retail stores 106a, 106b that are serviced, thereby ensuring prompt replenishment of items at retail stores 106a, 106b in response to demand.

In the context of the present disclosure, a transportation vessel management system is provided that assists in coordination of product shipments among and between nodes of the supply chain, and uses predictive models to automatically determine a optimization of total capacity of transportation vessels required to be allocated according to one or more allocation models (e.g., buy or rent). In some instances, the optimization corresponds to an overall number of transportation vessels, as well as a ratio of transportation vessels across allocation models within the supply chain of the enterprise to ensure a demand between each pair of locations within a forecast time period and service level are met. Accordingly, as noted below, substantial advantages are realized using the methods and systems of the present disclosure.

It is in a general supply chain retail environment that the following systems and methods operate. While the methods and systems are described in a retail environment having brick-and-mortar stores as well as online sales, additional applications are possible. For example, the systems and methods could operate for distribution channels that distribute supplies to multiple locations within a business that does not have retail locations.

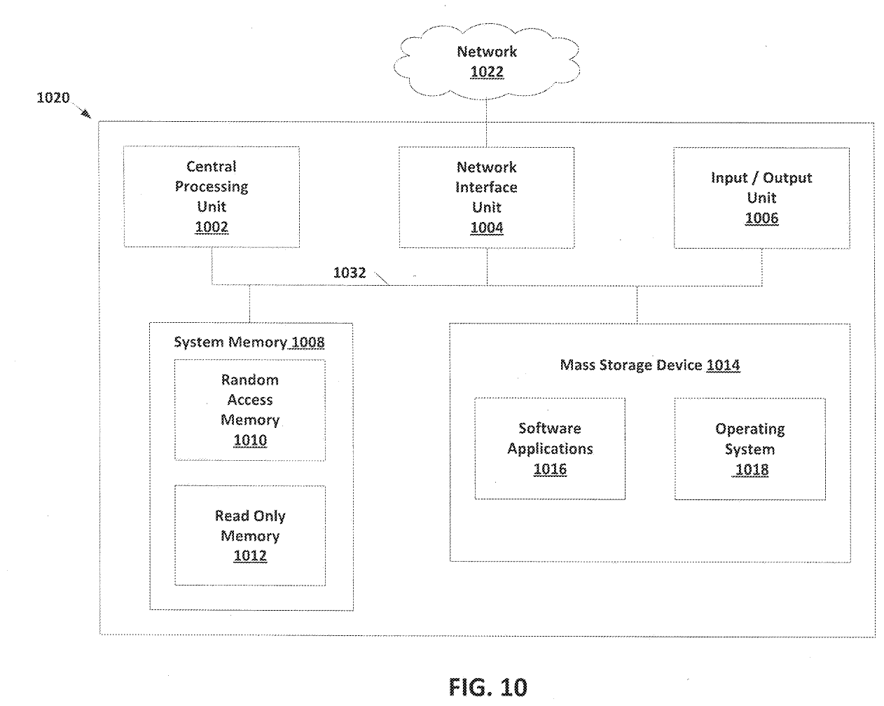

2 illustrates a schematic diagram of an example system 200 for implementing a transportation vessel management system 202. The transportation vessel management system 202 can be implemented in the form of a software tool executable on a computing device, such as the device seen in FIG. 10. Components of the of the transportation vessel management system 202 include an ingestion subsystem 212, a best fit engine 214, a modeler 216, and a vessel optimizer 218.

Each input received and each output provided is based on a pair of locations. The process described below is conducted on a per-pair-of-nodes basis.

The ingestion subsystem receives inputs from a transactional database, such as the data services 210a, 210b, 210c, and 210d. The transit time historical inputs are received by a transit time data service 210a, which is called by the transit time API after receiving a request from the ingestion subsystem 212. The dwell time historical inputs are received from the dwell time data service 210b by calling a dwell time API after receiving a request from the ingestion subsystem 212 Demand shipment historical inputs are received from a demand shipment data. service 210c, which is called by a demand shipment API after receiving a request from the ingestion subsystem 212. The trailer utilization inputs are received by a trailer utilization data service 210d, which is called by the utilization API after receiving a request from the ingestion subsystem 212.

Transit time historical inputs are defined as the time that it takes a transportation vessel to travel between a pair of notes. In an example, the transit time may be measured in minutes, hours, days, or weeks.

Dwell time historical inputs are defined as the time that a transportation vessel is not in transit. For example, dwell time includes the unload time at a destination location as well as the load time at origination location. Further, dwell time may include time that the transportation vessel is undergoing maintenance work, or is not being used (underutilization). Dwell time may also be measured in minutes, hours, days, or weeks.

Demand shipment historical inputs are defined as volume by class of product that is required to be shipped per week. Demand shipments are sorted by product class because different products may require a different type of transportation vessel. Demand shipments may be measured based on a volume class.

Trailer volume utilization inputs are defined as the percentage full an individual trailer is during a single route. A threshold may be 65% space utilization. For example, if a vessel volume is 1000 cu. ft., then 650 cu. ft. of the vessel is filled if the trailer volume utilization is 65%. Alternatively, the utilization may be a distribution within a predefined range, such as 50-70%. The historical values are obtained and a distribution is fit in a similar process as the other parameters.

In response to receiving the inputs, ingestion subsystem 212 provides the data to the best fit engine 214. The best fit engine 214 analyzes the data individually to determine a range and variance of the data within a historical time frame. Such analysis can include, for example, plotting the data graphically or mathematically. This process is repeated for each input received. If enough data is not received by best fit engine 214 to determine a range and variance, best fit engine 214 requests additional inputs from ingestion subsystem 212. If additional inputs are not available, ingestion subsystem 212 can call either of the transit time API, dwell time API, demand shipment API, or utilization API to request inputs from a longer period of time. In a first example, the last six months of data points may be received from the transit time data service 210a. However, if there is not enough data in the last six months, ingestion subsystem 212 may request data points from the last two years. The last six months of dwell time data points may be initially gathered by ingestion subsystem 212 and sent to best fit engine 214. The last two years of demand shipment data points may be initially gathered by ingestion subsystem 212 and sent to best fit engine 214. However, more or less time may be used to gather data points as needed. Alternatively, if there are not enough data points gathered, the best fit engine 214 fits a default distribution with derived parameters.

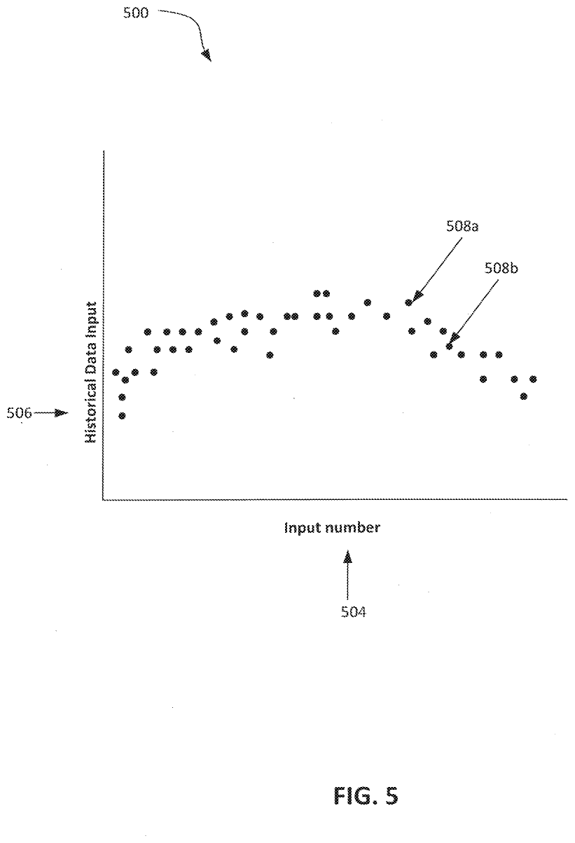

After best fit engine 214 determines a range and variance for each of the inputs individually, the best fit engine 214 provides an output (a set of data aggregates) to the modeler 216. The modeler 216 uses this information to create both a historical model 232 based on the input scenarios and a forecast model 234. The historical model 232 provides a model for each of the inputs individually, as well as the ability to overlay all of the imports into a single model. This is shown in more detail at FIG. 5.

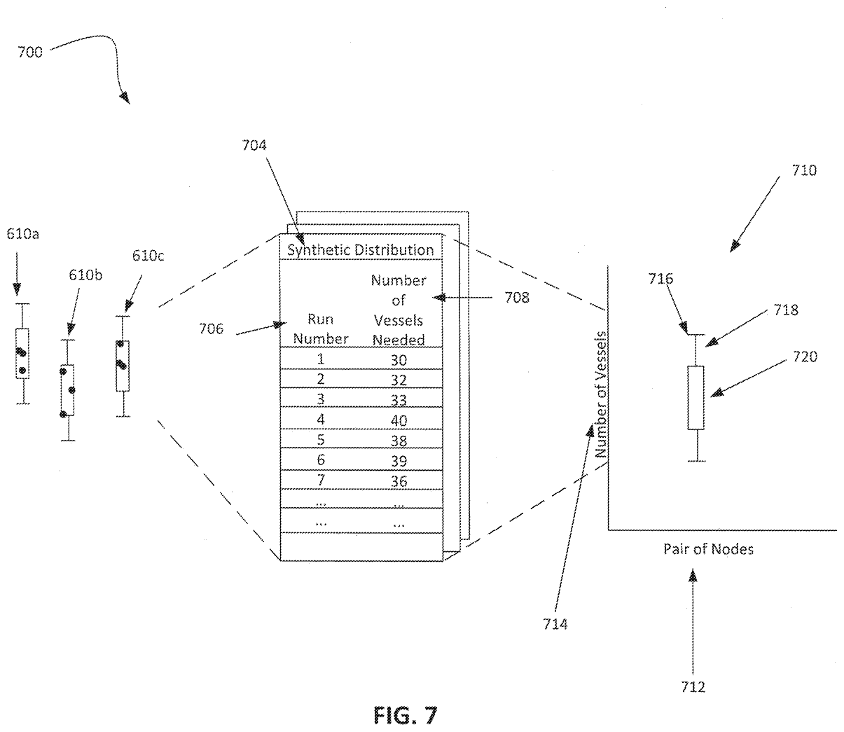

The modeler 216 includes the forecast model 234 and the historical model 232. The forecast model 234 and the historical model 232 utilize the same stochastic inputs to provide a prediction of the number of transportation vessels needed to reach a predetermined service level based on the historical inputs. The historical model 232 uses multiple demand scenarios generated from historical inputs by the best fit engine 214. The forecast model 234 uses demand inputs from a separate demand forecast model and has a single demand input. This process is described in more detail at FIG. 7.

The modeler 216 includes a vessel optimizer 218, which receives historical model 232 and a forecast model 234, which receives a single demand input. The vessel optimizer 218 outputs an optimum transportation vessel number to meet an optimum service level and a minimum cost. In a first example, the optimum service level is 98%. In another example, the optimum service level may be 95% or a lesser amount such as 90%.

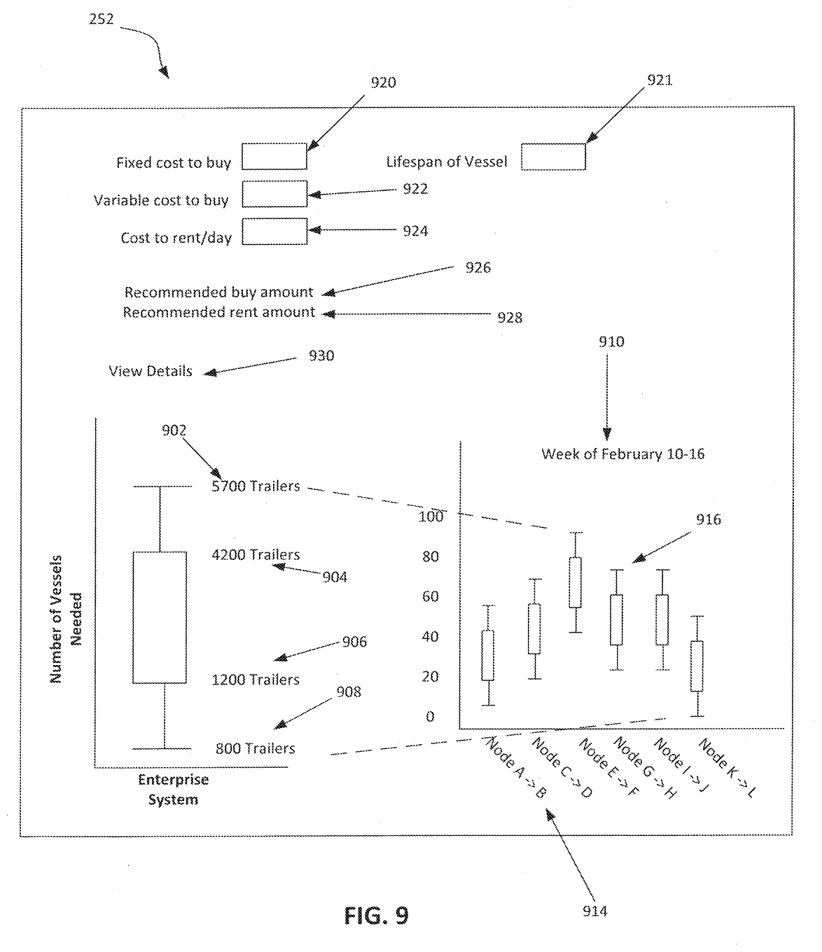

The vessel optimizer 218 also utilizes other factors to determine the optimum number of transportation vessels needed. Other factors include vessel types, vessel ownerships, vessel sizes, and transportation costs. Transportation costs include ownership costs such as maintenance costs, storage costs, and other costs associated with owning a transportation vessel. Transportation costs may also include rental costs, which are dependent on where the transportation vessel is needed, how long the transportation vessels is needed, and how far it travels. FIG. 9 illustrates an example for inputting such factors. The vessel optimizer 218 uses a stochastic model to determine the optimum ratio of owned and rented transportation vessels, since the historical inputs and other factors change over time.

The vessel optimizer 218 provides an amount of transportation vessels needed to meet the service level requirement to a user interface 252 of a connected computing device 250 via the network 222. The output provided by the vessel optimizer 218 is also communicated with a results database 254. The results database 254 can be accessed via the network 222 by the transportation vessel management system 202 and the computing device 250. As described in more detail below at FIG. 9, a user can input factor values, which are used to determine the recommended number of transportation vessels needed. The user interface 252 can be viewed by an administrative user of the transportation vessel management system 202 for implementation. In an example, the user interface 252 can provide a user with access to view and implement the recommended number of transportation vessel needed between a pair of nodes. In some examples, a user can view the recommended number of transportation vessels per type, size, or ownership. Still further, a user can view detailed information about transportation vessels, such as purchase date, rental date, maintenance schedules, and other similar information on a per-vessel basis.

The transportation vessel management system 202 communicates with a computing device 250 through a network 222. The network 222 can be any of a variety of types of public or private communications networks, such as the Internet. The computing device 250 can be any network-connected device including desktop computers, laptop computers, tablet computing devices, smartphones, and other devices capable of connecting to the Internet through wireless or wired connections.

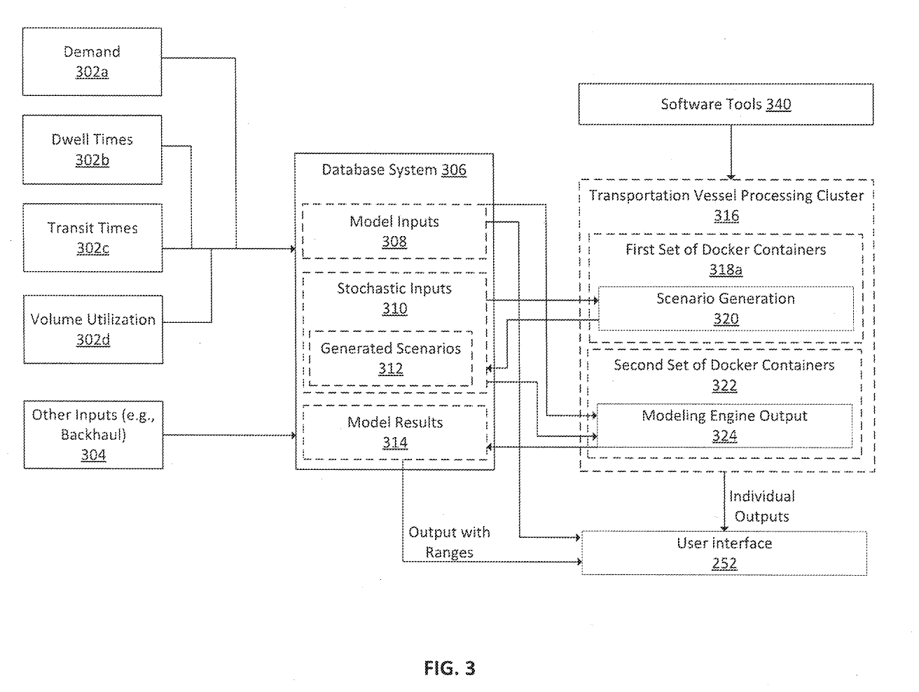

FIG. 3 illustrates a more detailed example system of modeler 216. Modeler 216 includes receiving data inputs, processing them at a database system 306 and a transportation vessel processing cluster 316, and providing an output to the user interface 252.

Data inputs selected from demand 302a, dwell times 302b, transit times 302c, and trailer utilization 302d (collectively referred to as “inputs 302”) are entered into the database system 306. Other inputs 304 include rental cost, fixed owned cost, and variable owned costs and are also entered into the database system 306. Unlike data inputs 302, which are taken from historical data, other inputs 304 may be entered by a user. Other inputs 304 include rental costs and ownership costs. Rental costs include the cost to rent a transportation vessel for a predetermined transit route (or distance) for a predetermined time, and for a type of vessel. Fixed ownership cost includes the initial cost of the transportation vessels, and variable owned costs include upkeep costs such as maintenance and storage.

The data inputs 302a, 302b, 302c, 302d and the other inputs 304 are fed to the database system 306. Database system 306 includes deterministic inputs 308, stochastic inputs 310 leading to generated scenarios 312, and model results 314. As described above, together these systems generate historical models and forecast models.

Transportation vessel processing cluster 316 allows containerized software workloads to be deployed for, e.g., analysis and reporting. In the example shown, the cluster 316 includes a first set of docker containers 318 that includes a scenario generator 320 and a second set of docket containers 322 that includes a modeler 324. Different software tools 340 are utilized by transportation vessel processing cluster 316 to run overall models and generate outputs to be sent to a user interface 252. It is noted that other containers could be used as well, and that separate containers can be used for purposes of scenario generation and modeling on a per-scenario, per-node-pair, per-region, overall, or some other logical basis. However, in the example shown, first and second containers are illustrated because a scenario generation stage and a modeling stage are performed in example embodiments described in further detail below.

In the embodiment shown, database system 306 provides deterministic inputs 308 to both modeler 324 and user interface 252. Stochastic inputs 310 are passed from database system 306 to scenario generator 320. The scenario generator 320 generates scenarios based on the information stored in the database system 306. In example scenarios, and as discussed further below, the scenario generator 320 will generate scenarios by randomly selecting parameters from a weighted distribution defined in the stochastic inputs 310, and generated scenarios are returned to the database system 306.

Generated scenarios 312 are passed to a modeler 324, which will optimize the mathematical construct with input scenarios and provide a number of transportation vessels required for the scenario to be tested. Model results 314 are passed to user interface 252. Scenario generator 320 also passes information back to generated scenarios 312 and modeler 324 passes information back to model results 314, which provides information to the user interface 252.

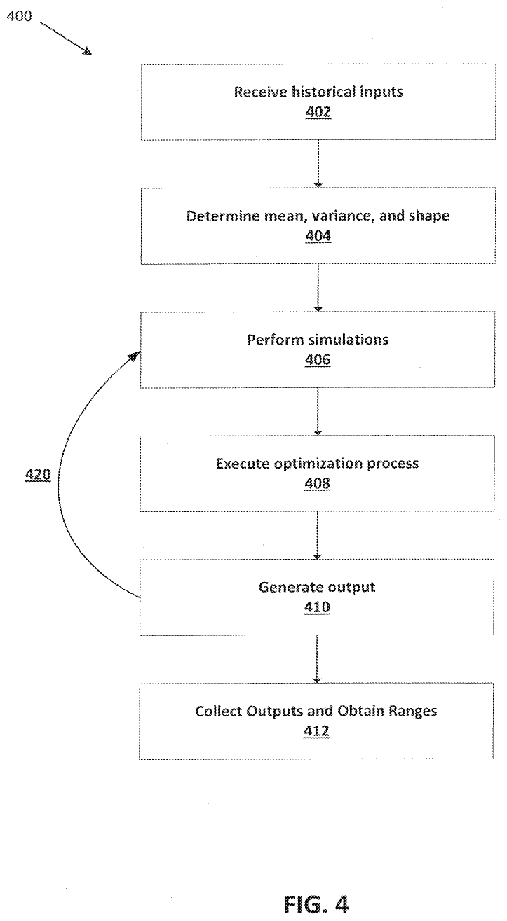

FIG. 4 illustrates an example method 400 of generating an output for managing transportation vessels within an enterprise system. As described in more detail below, steps 402, 404, and 406 are performed individually for each of the historical transportation vessel usage information inputs. At step 408, the information gathered from steps 402, 404, and 406 is used to execute an optimization process, and at step 410, an output is provided.

At step 402, a first historical input is received. A historical input is selected from a transit time, demand shipment, a dwell time, and a trailer volume utilization. Additional inputs may be considered as needed. Transit time between a pair of locations is defined as the time that the transportation vessel is in route between each the pairs of locations. Transit time is the time it takes the transportation vessel to travel between the first location and the second location, taking into consideration factors such as traffic, weather, and other similar things that may affect the time it takes for the vessel to travel between the first and second location. Historical information is gathered from the last 6 months of data currently available. Further, the inputs are dynamic, and may be continuously received and updated. Additionally, transit time between a pair of nodes may be affected by the route taken. In a typical case where a transportation vessel is loaded with goods and traveling between nodes between a distribution center and a store), this corresponds to the distance between those nodes, plus time for hook/unhook operations for the trailer. However, for backhaul loads, this may include not only the backhaul time, but any time required to travel out of the way for purposes of performing out-of-route backhaul deliveries for third parties. A post-processing method is used to determine backhaul time to improve accuracy of the results being reported.

Demand shipment is defined as volume by class of product that is required to be shipped per week. Demand shipments are sorted by product class because different products may require a different type of transportation vessel. For example, some food products need to be transported in a refrigerated vessel, while clothing items can be transported in a standard vessel. Further, large products may need to be shipped in a larger transportation vessel, while other products may fit in a smaller transportation vessel.

Dwell time is defined as the time the transportation vessel is not being used. For example, dwell time includes the unload time at a destination location as well as the load time at origination location. Further, dwell time may include time that the transportation vessel is not being used (underutilization).

The historical inputs are calculated as time or demand between a pair of locations. As shown in FIG. 1, pairs of locations may be between any two nodes, such as a vendor and a retail location. Information from established transportation routes is gathered, and can be used to predict future times along the established transportation routes, as well as new routes.

The transit time between a plurality of pairs of locations is gathered and plotted independently of the other historical inputs. Demand shipments between a plurality of pairs of locations is also gathered and plotted, and dwell times for a transportation vessel at each of the plurality of location is gathered. Each of these sets of historical information is gathered individually and independently on the pairs of locations. This information is shown as an example plot at FIG. 5.

Other factors that may affect historical inputs include information such as inventory type, type of transportation vessel (such as trailer, truck, and size of vessel), location of transit route (such as city or rural), time of year (such as holiday), and other similar inputs that contribute to the variation of inputs.

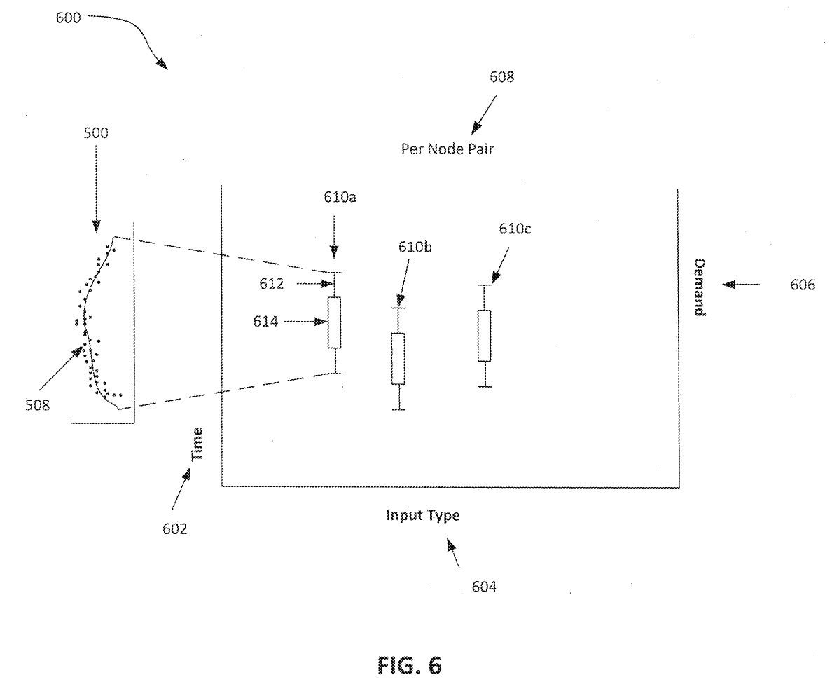

At step 404, a best fit distribution is determined. The best fit is determined using the historical transportation vessel usage inputs and a best fit is provided for each of the plurality of historical usage inputs. This is shown in more detail at FIG. 6. A best fit distribution identifies a mean, range, and variance parameters.

At step 406, a simulation using a randomly-selected value is performed for each of the inputs between each of the plurality of pairs of locations. The randomly-selected value is randomly generated and is selected by a weighting defined according to the best fit distribution of the corresponding historical usage characteristics. Each of the plurality of simulations generates an output individually for each of the historical inputs.

After the best fit distribution and simulations are performed for the first historical input, the process is repeated, for each of the other historical inputs. In an example method 400, steps 402, 404, and 406 are repeated for a total of three times.

In an example, the simulation is performed 50 times, while randomly selecting variable values in accordance with the distribution for each variable, e.g., weighted according to the best fit determination, which is used to predict future scenarios.

At step 408, an optimization process is executed. The optimization process determines an optimal (e.g., minimum) number of transportation vessels required to meet a predetermined service level. The minimum number of transportation vessels includes a distribution of transportation vessels types, sizes, and ownership type. The optimization process can also take into consideration inputs added by a user, including ownership costs and rental costs, in order to optimize the usage of owned transportation vessels and minimize costs.

TABLE 1
Rental Model Input Table for Transportation Vessels

| Transportation | | | Free | |
|---|---|---|---|---|
| Vessel Type | Daily | Mileage | Miles | Hours |
| Reefer, 48′-53′ | $50 | $0.04 | | $1.00 |
| Reefer, 48′-53′, Lift Gate | $60 | $0.08 | | $1.00 |
| Van, Road, 28′ | $10 | $0.04 | | |
| Van, Cartage, 48′-53′ | $8 | $0.04 | 100 | |

TABLE 2
Example Owned Model Input Table for Transportation Vessels

| | Purchase | Annualized | |
|---|---|---|---|
| Vessel Type | Cost | Cost | Maintenance |
| Reefer, 48′-53′ | $100,000 | $10,000 | $5,000 |
| Reefer, 48′-53′, Lift Gate | $120,000 | $12,000 | $6,000 |
| Van, Road, 28′ | $30,000 | $2,000 | $1,500 |
| Van, Cartage, 48′-53′ | $28,000 | $1,800 | $1,500 |

It is also noted that not all vessel types may be available for rental. Accordingly, optimization determines (1) what vessel types are required or useable for a particular anticipated demand load at a particular time, and (2) the cost-optimized breakdown of vessel types and ownership models for those vessel types given the anticipated demand and possible variance in demand. Example methodologies for performing vessel optimization are discussed in further detail below.

At step 410, an output is generated. In example embodiments, outputs are generated for each optimized scenario, including those generated from historical models and from a forecast model. The historical model uses historical demand scenarios, and the forecast model uses a single forecasted demand input. Use of historical models and forecast models allows for improved decision making, while minimizing modeling errors through triangulation of results from each of the models.

The output for each model includes a number of transportation vessels required to meet a demand for each pair of locations within a forecast time period. The output recommends an optimum distribution of transportation vessel types. Types of transportation vessels includes different sizes and specialties. Different specialties include standard, refrigeration, freight, lift gate, and dry.

After an output is generated for a first historical input, the simulation and optimization processes are repeated 420. In particular, for each simulation, an optimization process is performed and an output is generated, such that optimized outputs are generated for each simulated scenario (both historical and forecast). After the process has been repeated 420 an appropriate number of times (e.g., up to or exceeding 50 iterations on different scenarios), at step 412, all of the inputs are collected and a range of optimized outputs is obtained. Accordingly, a distribution can be provided that represents a range of possible numbers of transportation vessels and optionally a confidence interval that a particular range or value will meet a particular, predetermined service level.

FIG. 5 illustrates an example graphical representation 500 of data points 508a, 508b that make up example historical inputs. A graphical representation of data points is created for each of the inputs between each of the pairs of nodes. For illustrative purposes, the transit time is described; however, it should be noted that the same process is repeated for the transit time between different nodes as well as the dwell time and trailer volume utilization at each of the nodes and the demand between each pair of nodes. The data points shown on the graph represent the time it takes a transportation vessel to travel between a pair of nodes.

While only the transit time, dwell time, and demand shipment are shown and described in FIGS. 5-7, the inclusion of other inputs is within the scope of this disclosure. For example, utilization may be included as an input.

For the transit time historical input, the historical data input value 506 corresponds to a transit time, and the input number value 504 corresponds to a single trip between the pair of nodes. In an example, the trips between the pair of nodes are organized based on date. The data points 508a, 508b represent the historical transit times between each of the pairs of locations. The transit time inputs may be collected from at least the last 6 months of available data. In another embodiment, the transit time inputs may be collected from the last two years of available data.

Still further, transit time historical information may be plotted based on more specific factors, for example vessel type between a pair of locations. The vessel type may further be distinguished based on vessel size, vessel location, and vessel ownership

For the dwell time historical input, the historical data input value 506 corresponds to a dwell time, and the input number value 504 corresponds to a dwell time for a transportation vessel after completing a trip between two nodes. The dwell time inputs may be collected from at least the last 6 months of available data. In another embodiment, the dwell time inputs may be collected from the last three years of available data. Similar to transit time, dwell time may also be further plotted based on one or more of the specific factors stated above.

For the demand shipment historical input, the historical data input value 506 corresponds to a volume class, and the input number value 504 corresponds to a single trip between the pair of node. A volume class may be different types of products sold by the enterprise system, and may be divided by different methods. In a first example, a volume class is dependent on the supplier. In another example, the volume class is dependent on shipping requirements, such as refrigeration. The volume class inputs may be collected from at least the last 6 months of available data. In another embodiment, the volume class inputs may be collected from the last two years of available data.

The data points gathered are sent to the best fit engine, where the best fit engine determines the statistical distributions for each input. The mean, variance, and range parameters are estimated from the observed data points 508. This process can be repeated for various distributions and the best-fit distributions are selected.

FIG. 6 illustrates an example best fit historical model for transit time, dwell time, and demand. Each of the graphical representations 500 for the inputs is used to create each of the data aggregates 610a, 610b, and 610c. The normalized best fit model 600 is created on a per-node basis, so a different model 600 is created for each pair of nodes. Still further, the best fit model 600 is specific to a historical time period, and may be updated periodically or on an as-needed basis.

Generally, FIG. 6 illustrates a graphic depiction of distributions of each of the inputs, normalized, and shown on a single model 600 on a per node pair basis. The data aggregates 610a, 610b (transportation time and dwell time) are based on time 602, while aggregate 610c (demand shipment) is based on demand 606.

Each of the inputs is shown as a data aggregate 610a, 610b, 610c, is shown having a range 612 and a variance 614. The range and the variance reflect variations within the collected. data (e.g., from the plotted data points 508). For example, plotted data points 508 are shown as contributing to data aggregate 610a. Data aggregate 610b and data aggregate 610c are also/alternatively created using their respective data points 508.

In the example implementation shown, the data points collected for each individual input can be used to create a range 612 and variance 614 between each node pair. The range 612 and variance 614 may represent differing proportions of the data points. In a first example, the variance 614 represents 80% of the data points, and the range 612 represents all data points. In another example, the variance 614 represents 50% of the data points, and the range 612 represents 80% of the data points, which leaves the outlying 20% of data points are unneeded. However, any percentage or proportion may be used to represent the range 612 and variance 614.

As noted above, each of the data aggregates 610a, 601b, 610c represent data points on a per-node basis. A per-node basis can be between any two nodes within the enterprise system, so long as each of the data aggregates plotted together are for the same pair of nodes.

In example embodiments, a graphical distribution model 600 is made for each of the node pair combinations. It is noted that in the context of the present disclosure, a large number of data points may be collected for each node pair in a supply chain network, and a large number of node pairs may exist as well. As such, it may be difficult to directly use all of the data aggregates for purposes of optimization of transportation vessel capacity, due to processing constraints.

FIG. 7 illustrates an example method 700 of conducting a synthetic distribution process to generate a forecast output. Generally, the synthetic distribution process generates a distribution of needed transportation vessels based on a stochastically-weighted selection of experimental values used to generate scenarios, which in turn generate a required number or selection of transportation vessels to meet a predetermined service level. The method 700 performs such scenario-based experiments to avoid having to perform optimization calculations on each possible outcome of the possible outcomes due to actual data as to each node pair, thereby reducing the amount of processing time required to generate a representative model of transportation vessels required to meet the predetermined service level.

In the example embodiment, a modeler obtains the data aggregates 610a, 601b, 610c created by the historical model. Data aggregates 610a, 610b, 610c are used to determine a number of transportation vessels needed to meet a predetermined service level. Additionally, forecast model data can be used as well for purposes of simulation and optimization, to determine the number of transportation vessels required. In example embodiments, the data aggregates 610a-c may be created from either or both of the historical model and the forecast model.

For each of the inputs, a synthetic distribution 704 model is run. While only one set of results is shown, the synthetic distribution 704 model is run for each input for each pair of nodes. In the example shown, the number of vessels needed to meet a predetermined threshold level is determined. In an example, the predetermined service level is selected as 98%; however, any predetermined service level may be considered.

The synthetic distribution 704 model is run for the input data aggregates 610a, 610b, 610c, As shown in the example, at least seven runs 706 are conducted in the synthetic distribution 704 model, and the number of vessels needed 708 is determined. In an example, 50 runs 706 are conducted by synthetic distribution 704 model for each node pair.

The results from the synthetic distribution 704 model is shown in graph 710. The graph 710 plots the number of vessels 714 needed per pair of nodes 712. The number of transportation vessels needed is shown as a data aggregate 716 including both a range 720 and variance 718. The data aggregate 716 is representative of a range of a predicted number of vessels needed between each pair of nodes. The data aggregate 716 also illustrates the highest and lowest number of transportation vessels needed between a pair of nodes.

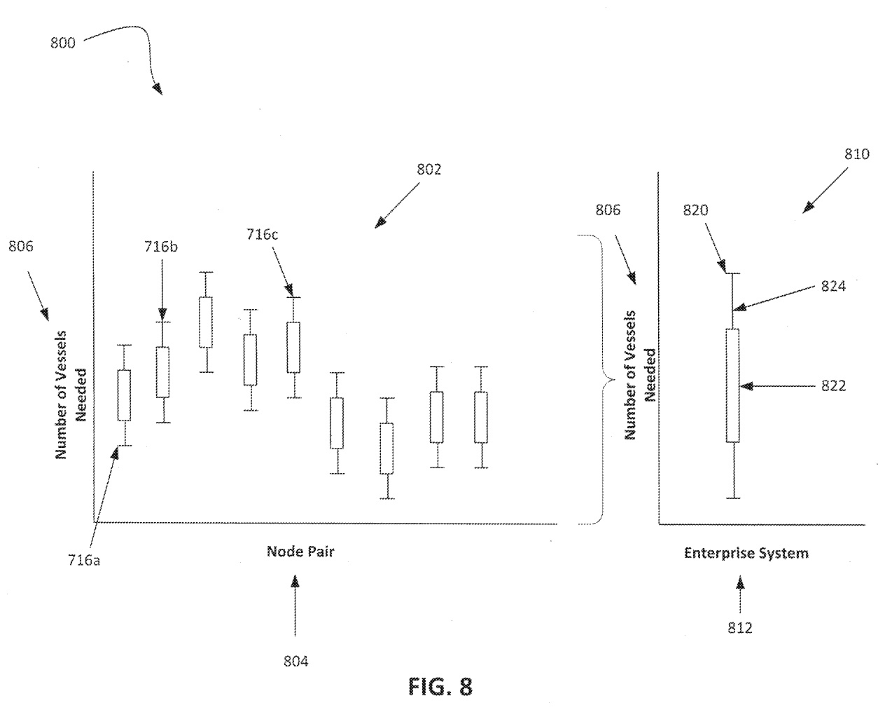

FIG. 8 illustrates an overview 800 of a graphical representation 802 of the number of transportation vessels needed on a per node basis and a graphical representation 810 of the number of transportation vessels needed for an enterprise system 812.

The graphical representation 802 shows data aggregates 716 representing the number of vessels needed 806 per node pair 804 based on the predictions from the synthetic distribution model. Each data aggregate 716a, 716b, 176c is used to represent the maximum and minimum number of vessels needed between each node pair 804 as well as the range and variance of vessels needed between each node pair 804. The minimum and maximum number of transportation vessels needed could be used to further distinguish the type of transportation vessels needed at a node pair.

The graphical representation 802 is also used to illustrate the different needs of different node pairs. For example, the third node pair requires a higher minimum than the maximum of the seventh node pair.

The distribution of data aggregates 716 may also be aggregated to a single data aggregate 820 that represents the total number of vessels needed 806 across an enterprise system 812. The data aggregate 820 includes a range 822 and variance 824. This information illustrates the need across the entire enterprise system and may be used to determine how many transportation vessels should be owned by an enterprise system. For example, the enterprise system may purchase at least the minimum of the range of the number of transportation vessels because it is more than likely that these transportation vessels are needed.

The vessel optimizer uses equation 1 to determine the optimum number of transportation vessels needed. in order to minimize the underutilization of transportation vessels, equation (1) is utilized to predict the optimum number of transportation vessels based on the stochastic inputs. The objective function of Equation (1) is to minimize the total costs and maximize the service level attained. Equation (1) takes into consideration the cost of movement of both rented and owned transportation vessels (Cₘ), the cost of owning and renting both loaded and empty transportation vessels (Cₒᵣ), the cost of holding empty transportation vessels at distribution centers (Cₕₑ), the cost of holding transportation vessels at retail locations (Cₕᵥ), and the cost of unmet demand (C_{ud}).

[Cₘ+Cₒᵣ+Cₕₑ+Cₕᵥ+C_{ud]} Eq. (1)

FIG. 9 shows an example user interface 252 including inputs from a user and outputs provided by the transportation vessel management system 202.

In order for the transportation vessel management system to determine an optimum number of transportation vessels needed, and to further determine the optimum number of transportation vessels to purchase and/or lease, inputs from a user are required. Inputs from a user include fixed cost to buy 920, a lifespan of the vessel 921, a variable cost to operate 922, and cost to rent 924.

A fixed cost to buy 920 is defined as the cost to purchase the trailer itself, and may be set as either a total or as a cost per day of owning a vessel, excluding operating costs. The lifespan of the vessel 921 is defined as the number of days that the vessel is expected to be in service. The variable cost to operate 922 is defined as costs associated with maintaining the vessel, such as maintenance and other similar costs. The cost to rent per day 924 is defined as the dollar amount that it costs to rent one trailer per day.

Once these inputs are provided, the vessel optimizer generates a recommended buy amount 926 and a recommend rent amount 928 based on the results provided by the optimization engine 218. D Since the inputs provided by the user and the historical data inputs used to determine how many vessels are needed between node pairs is variable, the vessel optimizer utilizes a stochastic modeling approach.

Details 930 are also presented for a user to view, which provides a breakdown of the recommended buy amount 926 and recommended rent amount 928. In the example shown, in order to reach a 98% optimization rate the number of transportation vessels needed would be between 800 and 5700 at any given time. Therefore, if the enterprise owns 5700 transportation vessels the enterprise system would be able to meet demand 98% of the time. If the enterprise system owns 4200 transportation vessels, the enterprise system would be able to meet demand 80% of the time. However, the exact number of transportation vessels to own and to rent is determined by the vessel optimizer based on the inputs provided by the user.

Details 930 also show how many transportation vessels are needed between pairs of nodes 914 and/or for a date range 910. The data aggregates 916 are used to determine how to distribute transportation vessels amount nodes within the enterprise system.

The vessel optimizer also determines how many transportation vessels the enterprise system should own and how many trailers on a price system should rent on a per-week, a per month, or a per year basis. The number of vessels needed in the enterprise system as shown may be tailored to a time frame as desired by the user.

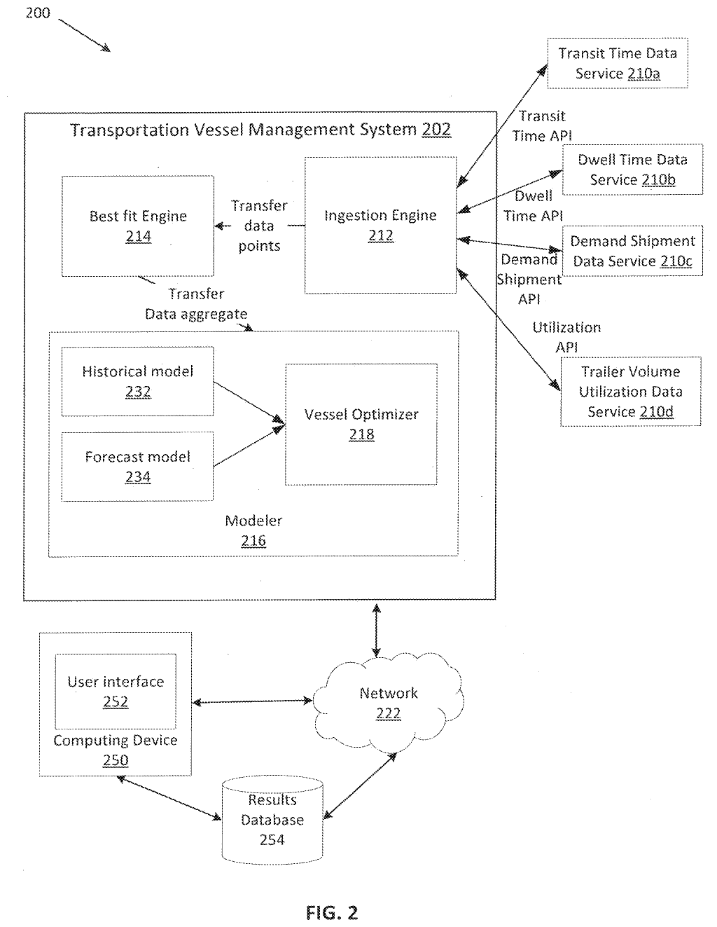

Referring now to FIG. 10, an example block diagram of a computing system 1020 is shown that is useable to implement aspects of the transportation vessel management system 202 of FIG. 2. In the embodiment shown, the computing system 1020 includes at least one central processing unit (“CPU”) 1002, a system memory 1008, and a system bus 1032 that couples the system memory 1008 to the CPU 1002. The system memory 1008 includes a random access memory (“RAM”) 1010 and a read-only memory (“ROM”) 1012. A basic input/output system that contains the basic routines that help to transfer information between elements within the computing system 1020, such as during startup, is stored in the ROM 1012. The computing system 1020 further includes a mass storage device 1014. The mass storage device 1014 is able to store software instructions and data.

The mass storage device 1014 is connected to the CPU 1002 through a mass storage controller (not shown) connected to the system bus 1032. The mass storage device 1014 and its associated computer-readable storage media provide non-volatile, non-transitory data storage for the computing system 1020. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 1002 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 1020.

According to various embodiments of the invention, the computing system 1020 may operate in a networked environment using logical connections to remote network devices through a network 1022, such as a wireless network, the Internet, or another type of network. The computing system 1020 may connect to the network 1022 through a network interface unit 1004 connected to the system bus 1032. It should be appreciated that the network interface unit 1004 may also be utilized to connect to other types of networks and remote computing systems. The computing system 1020 also includes an input/output controller 1006 for receiving and processing input from a number of other devices, including a touch user interface display screen, or another type of input device. Similarly, the input/output controller 1006 may provide output to a touch user interface display screen or other type of output device.

As mentioned briefly above, the mass storage device 1014 and the RAM 1010 of the computing system 1020 can store software instructions and data. The software instructions include an operating system 1018 suitable for controlling the operation of the computing system 1020. The mass storage device 1014 and/or the RAM 1010 also store software instructions, that when executed by the CPU 1002, cause the computing system 102.0 to provide the functionality discussed in this document. For example, the mass storage device 1014 and/or the RAM 1010 can store software instructions that, when executed by the CPU 1002, cause the computing system 1020 to receive and analyze inventory and demand data.

In accordance with the present disclosure, and in particular with respect to the computing device disclosed in FIG. 10, it is noted that in some instances, rather than direct execution of software instructions on computing hardware, a virtualization system may be implemented that is configured to host and execute software instructions within a virtualized environment. In such instances, a portion of an enterprise-wide pool of computing systems may be allocated for execution of software instructions on an as-needed basis, e.g., for scaling to accommodate execution of simulations as discussed above for purposes of trailer fleet optimization. Additionally, such simulations may be performed concurrently on separately-allocated virtual machines to assist with parallelization of the process described above.

Referring to FIGS. 1-10 generally, it is noted that the systems and methods described herein have a number of advantages over existing approaches for transportation planning. In particular, the systems and methods described herein account for various types of variability—e.g., variability in demand and variability of price between different ownership models for transportation vessels, and apply appropriate weighted models for ensuring that transportation vessels are available and allocated to routes or node pairs within a large-scale supply chain network at a predetermined service level. At the same time, the systems and methods described herein avoid having to calculate an optimized vessel ownership solution for every possible historical data point, but rather apply random sampling to that data for purposes of executing simulations of overall transit time. This extracts worst-case scenarios from random distributions of different types of data sets (e.g., transit time data, dwell time data, backhaul transit times, etc.) that may be functionally independent or only loosely interdependent, and therefore allows users to plan for and allocate transportation vessels according to worst case scenarios. For example, a scenario of high transit time combined with high dwell time and high demand may not have actually occurred in connection with one another in the past, but statistically might be likely to occur in the future. Such a scenario would be automatically captured and accommodated by the modeling, scenario execution, and optimization processes discussed herein.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method of managing transportation vessels within an enterprise system, the method comprising:
receiving, at a software tool implemented on a computing system, inputs related to historical transportation vessel usage, the inputs including a historical demand level and a plurality of historical usage characteristics for each of a plurality of pairs of locations;
automatically determining from the historical transportation vessel usage information, a best fit distribution for each of the plurality of historical usage characteristics and the historical demand;
performing, for each of the plurality of pairs of locations, a plurality of simulations using a randomly-selected value for each of a plurality of usage characteristics, the randomly-selected value being weighted according to the best fit distribution of the corresponding historical usage characteristics,
wherein each of the plurality of simulations includes an optimized output of a number of transportation vessels required to meet a demand for each pair of locations, such that the outputs of the plurality of simulations result in a range of numbers of transportation vessels required to meet a predetermined service level.

2. The method of claim 1, wherein the transportation vessels include transportation vessels of a plurality of types, the plurality of types varying based on size and specialty.

3. The method of claim 2, wherein the specialty is selected from standard, refrigeration, freight, lift gate, and dry.

4. The method of claim 1, wherein the plurality of transportation vessels including transportation vessels of a plurality of classifications, the plurality of classifications varying based on a cost model.

5. The method of claim 4, wherein the optimized number of transportation vessels required to meet the predetermined service level is determined based on a combination of transportation vessels of the plurality of classifications, and wherein the optimized number corresponds to a minimum cost associated with operation of the transportation vessels.

6. The method of claim 4, wherein the cost model includes one or more inputs selected from among: fixed purchase costs, variable purchase costs, rental costs, leasing costs, currency and/or exchange rate fluctuations, and fuel costs.

7. The method of claim 1, wherein the usage characteristics include transit time between pairs of locations, dwell time, demand shipment, and trailer volume utilization.

8. The method of claim 7, wherein dwell time includes unloading time, and unused time.

9. The method of claim 1, wherein the predetermined service level is the percentage of time that a delivery is on time.

10. The method of claim 9, wherein the predetermined service level is 98%.

11. The method of claim 1, wherein the transportation vessels include vessels owned by the enterprise system and vessels leased by the enterprise system.

12. . The method of claim 1, wherein the optimization process is executed once per week.

13. A system for managing transportation vessels within an enterprise system, the system comprising:
a computing system including a data store, a processor, and a memory communicatively coupled to the processor, the memory storing instructions executable by the processor to:
receive inputs related to historical transportation vessel usage, the inputs including a historical demand level and a plurality of historical usage characteristics for each of a plurality of pairs of locations;
determine, from the historical transportation vessel usage information, a best fit distribution for each of the plurality of historical usage characteristics and the historical demand;
perform, for each of the plurality of pairs of locations, a plurality of simulations using a randomly-selected value for each of a plurality of usage characteristics, the randomly-selected value being weighted according to the best fit distribution of the corresponding historical usage characteristics,
wherein each of the plurality of simulations includes an optimized output of a number of transportation vessels required to meet a demand for each pair of locations, such that the outputs of the plurality of simulations result in a range of numbers of transportation vessels required to meet a predetermined service level.

14. The system of claim 13, wherein the plurality of transportation vessels including transportation vessels of a plurality of classifications, the plurality of classifications varying based on a cost model.

15. The system of claim 14, wherein the optimized number of transportation vessels required to meet the predetermined service level is determined based on a combination of transportation vessels of the plurality of classifications, and wherein the optimized number corresponds to a minimum cost associated with operation of the transportation vessels.

16. The system of claim 14, wherein the cost model includes inputs selected from purchase fixed costs, purchase variable costs, and rental costs.

17. The system of claim 13, wherein the usage characteristics include transit time between pairs of locations, dwell time, demand shipment, and trailer volume utilization.

18. The system of claim 13, further comprising generating via the computing system, a user interface providing a selectable view of the optimized number of transportation vessels required to meet a predetermined service level at one or more of the plurality of pairs of locations.

19. A non-transitory computer-readable medium comprising computer-executable instructions which, which executed by a computing system cause the computing system to perform a method of managing inventory items in a supply chain, the method comprising:
receiving, at a software tool implemented on a computing system, inputs related to historical transportation vessel usage, the inputs including a historical demand level and a plurality of historical usage characteristics for each of a plurality of pairs of locations;
automatically determining from the historical transportation vessel usage information, a best fit distribution for each of the plurality of historical usage characteristics and the historical demand;
performing, for each of the plurality of pairs of locations, a plurality of simulations using a randomly-selected value for each of a plurality of usage characteristics, the randomly-selected value being weighted according to the best fit distribution of the corresponding historical usage characteristics,
wherein each of the plurality of simulations includes an optimized output of a number of transportation vessels required to meet a demand for each pair of locations, such that the outputs of the plurality of simulations result in a range of numbers of transportation vessels required to meet a predetermined service level.

21. The method of claim 20, wherein the plurality of transportation vessels including transportation vessels of a plurality of classifications, the plurality of classifications varying based on a cost model.

22. The method of claim 21, wherein the optimized number of transportation vessels require to meet the predetermined service level is determined based on a combination of transportation vessels of the plurality of classifications, and wherein the minimum number corresponds to a minimum cost associated with operation of the transportation vessels.

23. The method of claim 21, wherein the cost model includes inputs selected from purchase fixed costs, purchase variable costs, and rental costs.

24. The method of claim 20, wherein the usage characteristics include transit time between pairs of locations, dwell time, and demand shipment.
